(19) United States
(12) Patent Application Publication
(10) Pub. No.: US 2025/0230026 A1
(43) Pub. Date: Jul. 17, 2025

(54) FILLING DEVICE AND DEVICE

(71) Applicant: Komptech GmbH, Frohnleiten (AT)

(72) Inventors: Johann NESSHOLD, Stainz (AT); Christoph MORITZ, Geistthal-Södingberg (AT)

(21) Appl. No.: 19/020,919

(22) Filed: Jan. 14, 2025

(30) Foreign Application Priority Data
Jan. 15, 2024 (DE) 10 2024 101 073.8

(51) Int. Cl. B67C 11/02; B02C 23/02

(52) U.S. Cl. CPC B67C 11/02; B02C 23/02

(57) ABSTRACT

The present disclosure relates to a filling device for filling matter into a device, wherein the filling device comprises a movable element or a plurality of movable elements.

### CROSS REFERENCE TO RELATED APPLICATION

The present application claims priority to German Patent Application No. 10 2024 101 073.8 filed on Jan. 15, 2024. The entire contents of the above-listed application are hereby incorporated by reference for all purposes.

### TECHNICAL FIELD

The present disclosure relates to a filling device for filling matter into a device.

### BACKGROUND

Funnel-shaped filling devices are known which allow for simple filling of matter into a device.

### SUMMARY

However, the funnel shape of such filling devices requires dimensions both in height and in width which for example allow for oblique walls and thus a funnel function, for example in that filling is possible not directly above a filling opening of the device, but rather horizontally offset therefrom. However, the dimensions make for example the transport of devices having funnel-shaped filling devices more difficult.

Against this background, the object of the present disclosure is that of improving an above-mentioned filling device, in particular in view of the mobile and spatial flexibility.

This object is achieved by the subject matter as described herein.

According thereto, it is provided according to the disclosure that the filling device comprises a movable element or a plurality of movable elements.

It is optionally provided that the matter is or comprises waste and/or one or more organic, in particular compostable, substances, such as wood or green waste.

Optionally, within the context of this disclosure, an element being “movable” is to be understood to mean that an element is movable in itself, i.e. a part of the element is movable relative to the element itself, and/or that the element is movable relative to the filling device.

The device can be a comminuting device.

It is optionally provided that the element or elements comprise or are an, in particular folding, wall, an actuator, in particular a hydraulic cylinder, a lever, a lever mechanism, and/or a hinge. The actuator or actuators can also be pneumatic cylinders.

It is optionally provided that the element or the elements are rotatably mounted and/or folding.

It is optionally provided that the elements comprise four movable walls.

The filling device optionally comprises four rotatably mounted walls, in particular side walls, which can each be actuated and/or moved via one or more lever mechanisms, in particular lever gears, in particular in each case or as a whole by means of one or more hydraulic cylinders.

It is optionally provided that a folding corner is arranged once or twice in each case, between two or more elements, in particular walls, of the filling device.

Optionally folding corners are attached via hinges in the two front corners of the filling device, which folding corners optionally prevent or avoid matter falling out of and/or beside the filling device during filling of matter by means of the filling device.

It is optionally provided that a dimension, in particular a height and/or width of the filling device, can be changed by moving the element or the elements.

It is optionally provided that the element or the elements can be moved from one position into a perpendicular position, and/or from one position into a less perpendicular position.

It is optionally provided that the element or the elements can be moved from an almost horizontal position into an almost perpendicular or oblique position, and/or from an almost perpendicular or oblique position into an almost horizontal position.

In an almost perpendicular or almost horizontal position, the element optionally assumes an angle of less than 30°, 20° or 10° relative to the perpendicular or horizontal.

In an oblique position, the element optionally assumes an angle of 20° or 30° up to 50° or 60°, in particular 45°, relative to the horizontal.

It is optionally provided that the element or the elements form a folding funnel or comprise a folding funnel.

Optionally the filling device is a folding funnel or comprises a folding funnel, in particular for a comminuting machine. A folding funnel is optionably configured in such a way that the funnel can be brought from a folded up into a folded out, and from a folded out into a folded up, operating state.

Optionally, in a folded out operating state of the filling device, as large as possible a filling volume of the device, and in a folded up operating state of the filling device the most compact possible transport dimensions, can be ensured.

The disclosure also relates to a device, in particular comminuting device, comprising a filling device according to the disclosure.

It is noted at this point that the terms “a” and “an” do not necessarily refer to precisely one of the elements, even if this constitutes a possible embodiment, but rather can also refer to a plurality of the elements. Likewise, the use of the plural also includes the presence of the element in question in the singular and, vice versa, the singular also includes a plurality of the elements in question. Furthermore, all the features of the disclosure described herein can be combined with one another as desired or claimed in isolation from one another.

### BRIEF DESCRIPTION OF THE FIGURES

Further advantages, features and effects of the present disclosure emerge from the following description of embodiments with reference to the figures, in which identical or similar components are denoted by the same reference signs. In the figures:

FIG. 1: is a perspective view of an embodiment of a filling device according to the disclosure, in a folded out operating state.

FIG. 2: is a plan view of the embodiment of a filling device according to the disclosure, in a folded out operating state.

FIG. 3: is a side view of the embodiment of a filling device according to the disclosure, in a folded out operating state.

FIG. 4: is a rear view of the embodiment of a filling device according to the disclosure, in a folded out operating state.

FIG. 5: is a perspective view of the embodiment of a filling device according to the disclosure, in a folded up operating state.

FIG. 6: is a plan view of the embodiment of a filling device according to the disclosure, in a folded up operating state.

FIG. 7: is a side view of the embodiment of a filling device according to the disclosure, in a folded up operating state.

FIG. 8: is a rear view of the embodiment of a filling device according to the disclosure, in a folded up operating state.

FIG. 9: is a perspective view of an embodiment of a device according to the disclosure comprising a filling device in a folded out operating state.

FIG. 10: is a plan view of the embodiment of a device according to the disclosure comprising a filling device in a folded out operating state.

FIG. 11: is a side view of the embodiment of a device according to the disclosure comprising a filling device in a folded out operating state.

FIG. 12: is a rear view of the embodiment of a device according to the disclosure comprising a filling device in a folded out operating state.

FIG. 13: is a perspective view of the embodiment of a device according to the disclosure comprising a filling device in a folded up operating state.

FIG. 14: is a plan view of the embodiment of a device according to the disclosure comprising a filling device in a folded up operating state.

FIG. 15: is a side view of the embodiment of a device according to the disclosure comprising a filling device in a folded up operating state.

FIG. 16: is a rear view of the embodiment of a filling device according to the disclosure, in a folded up operating state.

### DETAILED DESCRIPTION

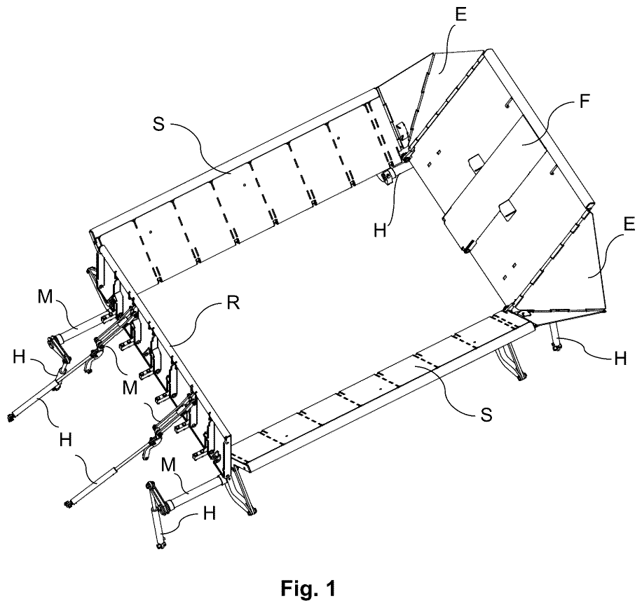

FIG. 1 shows a funnel-shaped filling device.

The filling device comprises four walls S, R and F, wherein two of the walls are side walls S, one of the walls is a rear wall R, and one of the walls is a front wall F. The designations “front wall” and “rear wall” serve for improved description of the position of the respective walls and optionally do not include any specification with respect to a front or rear side of the filling device. It can optionally be provided that the walls are arranged, according to their designation, more at a front or a rear side of a device comprising the filling device.

The four walls optionally form a funnel, wherein the upper opening of the filling device is larger i.e. the lower opening. This is achieved by at least one oblique wall.

As is shown in FIG. 1, the side walls S and the front wall Fare positioned obliquely. The rear wall R is almost perpendicular.

The filling device comprises a plurality of hydraulic cylinders H and a plurality of mechanisms M in the form of lever mechanisms.

A mechanism M is connected to one of the walls S, For R and at least one hydraulic cylinder H in such a way that the respective wall S, F or R can be moved by extending and/or retracting the hydraulic cylinder H, via the mechanism M.

Two mechanisms M are hinged to the rear wall R. The mechanisms M hinged to the rear wall are in each case hinged to a device not shown in FIG. 1 and a hydraulic cylinder H, wherein each of the hydraulic cylinders H is in turn hinged to the device not shown in FIG. 1.

Two mechanisms M, optionally one mechanism M at the front and back in each case, are hinged to each side wall S, in particular to the side regions. The mechanisms M hinged to each side wall are in each case hinged to a device not shown in FIG. 1 and a hydraulic cylinder H, wherein each of the hydraulic cylinders H is in turn hinged to the device not shown in FIG. 1.

Foldable or folding corners E are arranged between the front wall F and the respective side walls S adjoining this.

Each folding corner E comprises two wings which are interconnected in a folding by a piano hinge. Each of the corners E is connected in a folding manner via a piano hinge to a side wall S and via a piano hinge to the front wall F. Each wing of a corner E is thus connected to a wall via a piano hinge. Instead of piano hinges, any other folding connection is also conceivable.

The walls S, R and Fare optionally welded structures.

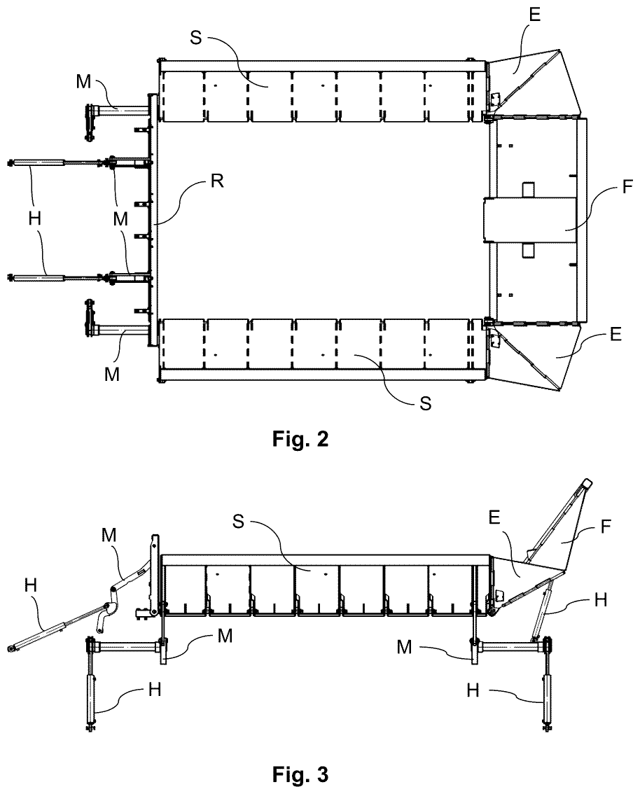

FIG. 2 is a plan view of the filling device from FIG. 1. The rear wall R is optionally completely perpendicular.

As can be seen from FIG. 3, a, optionally two, hydraulic cylinder(s) H is hinged directly to the front wall F. The actuators in the form of hydraulic cylinders can thus be directly hinged to a wall or indirectly hinged to a wall via a mechanism M.

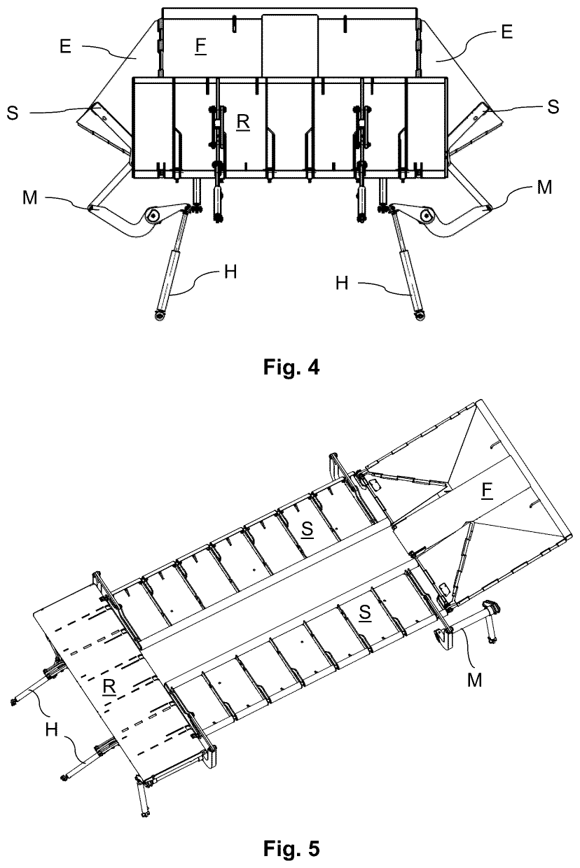

The mechanisms M hinged to the rear wall R optionally comprise a toggle lever, as is shown above all in FIG. 3. The mechanisms M hinged to the side walls S optionally comprise one or more eccentrics and a shaft, as is shown above all in FIG. 4.

FIGS. 1 to 4 show the filling device in a folded out operating state.

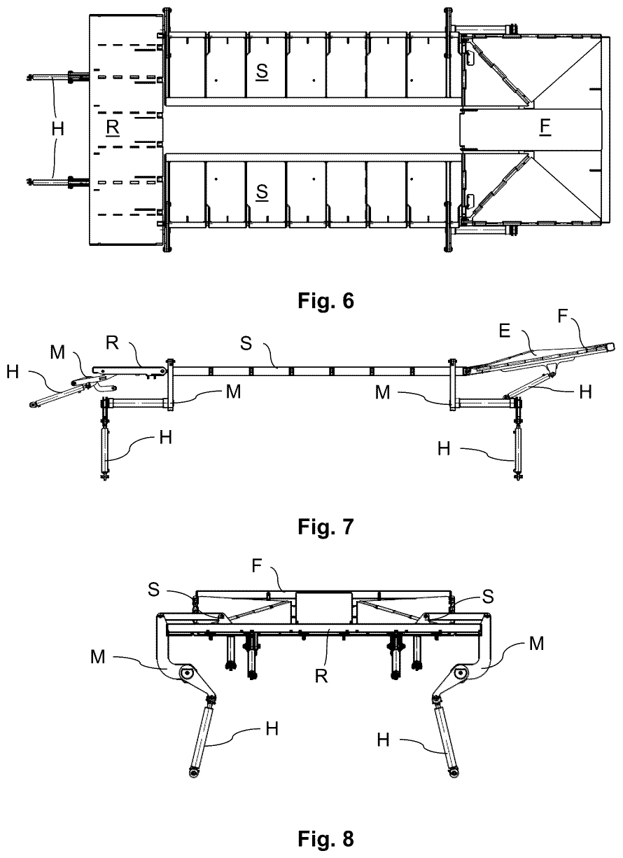

FIGS. 5 to 8 show the filling device in a folded up operating state. The hydraulic cylinders H and the mechanisms M assume a position corresponding thereto.

In a folded up operating state, the walls S, R and F are almost in an almost horizontal position. The folding corners are folded up, likewise in an almost horizontal position.

In the folded out operating state, the filling device is optionally in a working position. In the folded up operating state, the filling device is optionally in a transport position.

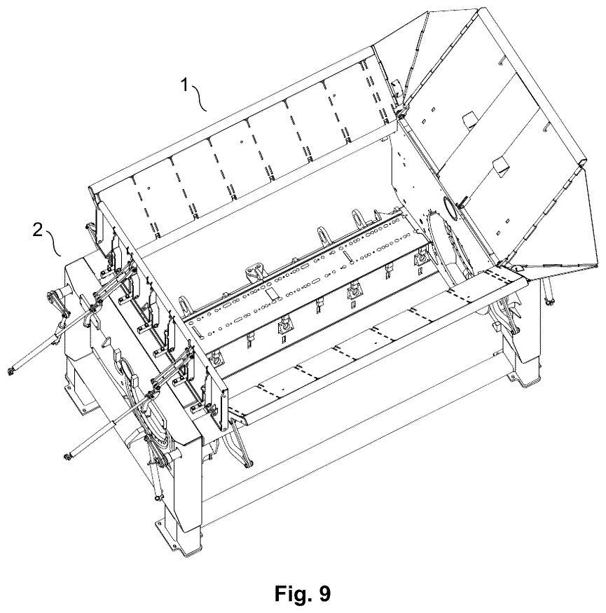

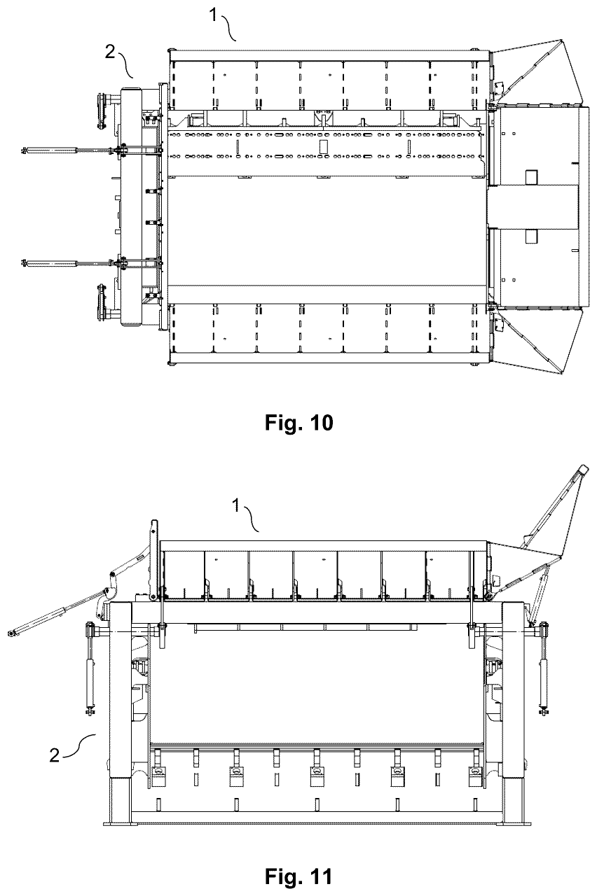

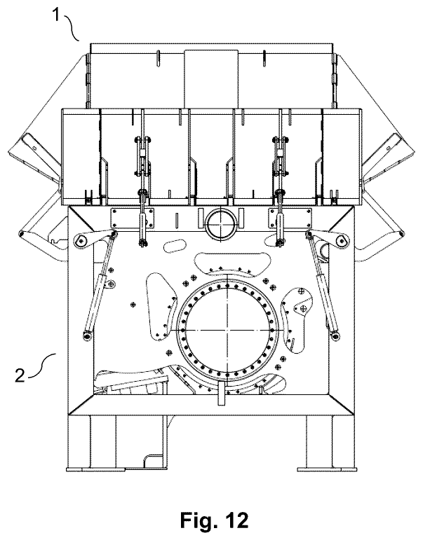

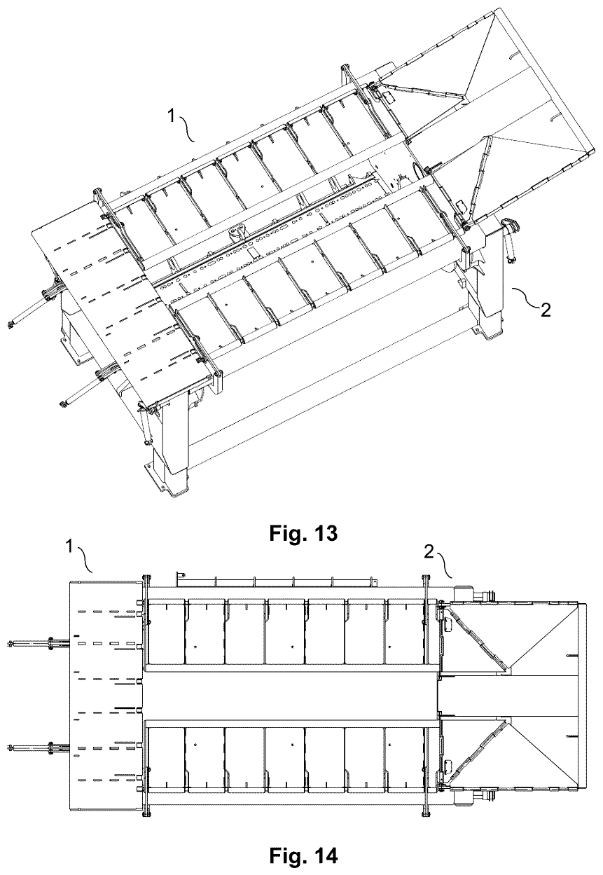

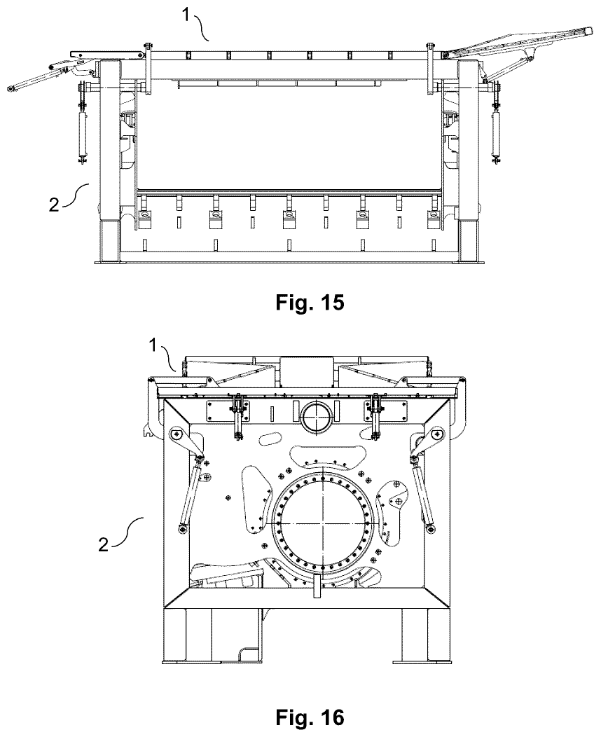

FIGS. 9 to 16 show a device 2 comprising a filling device 1, wherein the filling device 1 is folded out in FIGS. 9 to 12 and is folded up in FIGS. 13 to 16. The device 2 is a base machine of a comminuting device.

The filling device 1 is arranged on the device 2. The figures are drawn to scale, although other relative dimensions may be used.

1. Filling device for filling matter into a device, wherein the filling device comprises a movable element or a plurality of movable elements.

2. Filling device according to claim 1, wherein the element or elements comprise or are a folding, wall, an actuator, a lever, a lever mechanism, and/or a hinge.

3. Filling device according to claim 1, wherein the element or the elements are rotatably mounted and/or folding.

4. Filling device according to claim 1, wherein the elements comprise four movable walls.

5. Filling device according to claim 1, wherein a folding corner is arranged once or twice in each case, between two or more elements of the filling device.

6. Filling device according to claim 1, wherein a dimension can be changed by moving the element or the elements.

7. Filling device according to claim 1, wherein the element or the elements can be moved from one position into a perpendicular position, and/or from one position into a less perpendicular position.

8. Filling device according to claim 1, wherein the element or the elements can be moved from an almost horizontal position into an almost perpendicular or oblique position, and/or from an almost perpendicular or oblique position into an almost horizontal position.

9. Filling device according to claim 1, wherein the element or the elements form a folding funnel or comprise a folding funnel.

10. Device comprising a filling device according to claim 1.

11. Filling device according to claim 5, wherein the two or more elements are walls.

12. Filling device according to claim 6, wherein the dimension is a height and/or width of the filling device.

13. Device according to claim 10, wherein the device is a comminuting device.
